(19) United States
(12) Patent Application Publication
(10) Pub. No.: US 2012/0037309 A1
(43) Pub. Date: Feb. 16, 2012

(54) Method for connecting, as well as a connection, of a capillary tube to a main tube

(76) Inventor: Donald Herbst, Berlin (DE)

(21) Appl. No.: 13/138,311

(22) PCT Filed: Jan. 25, 2010
(86) PCT No.: PCT/EP2010/000514

§ 371 Date: Oct. 6, 2011

(30) Foreign Application Priority Data
Feb. 2, 2009 (DE) 10 2009 007 582.8

(51) Int. Cl. F16L 47/26; B29C 65/18

(52) U.S. Cl. 156/256; 285/41

(57) ABSTRACT

The invention relates to a method for connecting the open end of a thin-walled plastic tube having an outside diameter of up to 3 mm (capillary tube) to a main tube made of plastic and having a considerably larger diameter, such that the capillary tube projects radially from the circumferential surface of the main tube, and the interior of the capillary tube is connected to the interior of the main tube by way of a radial passage configured in the wall of the main tube. One end of the capillary tube, which has an outside diameter that equals or is smaller than the diameter of the passage, is at least partially inserted into the passage from the outside, and at least part of the inserted end of the capillary tube and the immediately surrounding part of the wall of the passage in the main tube are subsequently heated in common. Said parts are thus softened such that they are fused to one another after cooling. The heating preferably takes place by inserting a heated punch into the passage from the inside of the main tube.

The invention relates to a method according to the preamble of claim 1, as well as to a connection according to the preamble of claim 13.

DE 197 25 326 C2 describes a method for manufacturing a mat with thin-walled plastic tubes with a continuous equal diameter up to 5 mm (capillary tubes) which at their open ends in each case are welded to main tubes by way of heating and pressure, in a manner in which they depart radially from this main tube, for supplying and leading away a heating/cooling medium. The main tubes at the welding locations comprise bores with a diameter which corresponds roughly to the inner diameter of the plastic tubes. The plastic tubes are led to the main tubes from the outside, wherein they were previously heated in their end-regions to be welded, such that the inner diameter of the end regions was widened. In this manner, one succeeds in the welding zone not connecting directly to the bore in the main tube, but being displaced outwards away from this, so that no danger of the closure or at least narrowing of the bore due to melted material exists. However, a relatively large welding surface (welding corona) is formed around the bore, so that the heat required for welding must be accordingly increased. A heating of the main tube is also necessary. This, additionally to an increased heat loss, results in an extended heating-up time, as well as an extended cooling time, so that the mat manufacture becomes uneconomical. Moreover, the achievable minimum distance between the capillary tubes is increased by way of the welding corona.

A method for the radial fastening of small tubes (tubelets) with a small diameter to a main tube with a large diameter by way of welding is known from EP 0 964 212 A2. The ends to be fastened of the small tubelets are heated so that they melt. Simultaneously, a flange which is attached at the outside on the main tube is heated such that it melts. The ends of the tubelets are then pressed through the flange against the outer wall of the main tube, wherein end-side openings of the tubelets are aligned with radial passages through the wall of the main tube. After cooling, the melted regions of the tubelets and of the flange, the tubelets and the main tube are welded to one another in a sealed manner. This method, although permitting a very close minimum distance between the tubelets, however on the other hand requires the heating of the flange and thus a significant supply of heat, together with correspondingly long heating and cooling times. The provision of the flange causes an additional expense with regard to work and material. Also, it is not ensured that the free passage cross section of the melted ends of the tubelets is fully maintained.

Moreover, a tube consisting of plastic and for the passage of a heating or cooling medium, with an outer diameter of up to 5 mm and an inner diameter of up to 3 mm, is known form DE 10 2006 004 828 A1. The wall thickness of this tube in an end region is reinforced by way of the inner diameter of the tube in this end region being smaller than the inner diameter over the remaining tube length. Due to this, the end region of the tube is designed in such a mechanically stable manner, that no supporting pins in the inside of the tube are required for welding to the main tubes. Since furthermore the outer diameter of the tube is not enlarged in the end region, the tubes may be welded onto the main tube with a very close mutual distance.

It is therefore the object of the present invention, to provide a method for connecting the open end of a thin-walled plastic tube with an outer diameter of up to 5 mm (capillary tube), to a main tube of a significantly larger diameter and consisting of plastic, in a manner such that the capillary tube projects radially from the peripheral surface of the main tube, and the inside of the capillary tube is connected via a radial passage formed in the wall of the main tube, to the inside of the main tube, as well as a connection manufactured according to this method, which permit a very close distance between adjacent capillary tubes and moreover require only a small quantity of heat, so that the heating and cooling may be effected in a very short time. Moreover, the inner cross section of the capillary tubes as well as also of the passages through the main tube should not be restricted or only in a defined manner, in the connection region.

According to the invention this object is achieved by a method with the features of claim 1 as well as by a connection with the features of claim 13. Advantageously further formations of this method as well as of this connection are to be deduced from the respective dependent claims.

By way of the fact that a capillary tube whose end has an outer diameter which corresponds to the diameter of the passage or is smaller is applied, that the end of the capillary tube is introduced from the outside at least partly into the passage and that a common heating at least of a part of the introduced end of the capillary tube and of the directly surrounding part of the wall of the passage in the main tube is carried out such that these are plasticised and are welded to one another after cooling, the capillary tube and the main tube are only heated in the direct region of the welding zone, so that a minimal quantity of heat needs to be supplied. Apart from this energy saving, extremely short heating and cooling times arise, so that the method has a high economical utilisation. Since the inner cross section of the capillary tube is practically not changed or only in a defined scope, the flow of the medium flowing through the connection may be controlled in a controlled manner. Furthermore, the shape stability of the main tube is ensured, since this, given a greater heating, has the tendency to bend. Finally, an optically pleasing connection is obtained, since the welding zone is not visible from the outside.

The heating may preferably be carried out by way of introducing a heating punch from the inside of the main tube into the passage. This, due to its shape, may be brought into direct contact with only the end-face of the capillary tube and with a small region of the inner surface of the capillary tube according to the desired extent of the welding seam in the longitudinal direction of the capillary tube. Thus only the material at the end of the capillary tube is plasticised or melted in a length according to the width of the welding seam as well as of the directly adjacent region of the main tube. Advantageously, the heating punch has the shape of a truncated cone with a peripheral surface tapering weakly in the direction of the capillary tube.

The invention is hereinafter explained in more detail by way of embodiment examples represented in the figures. There are shown in:

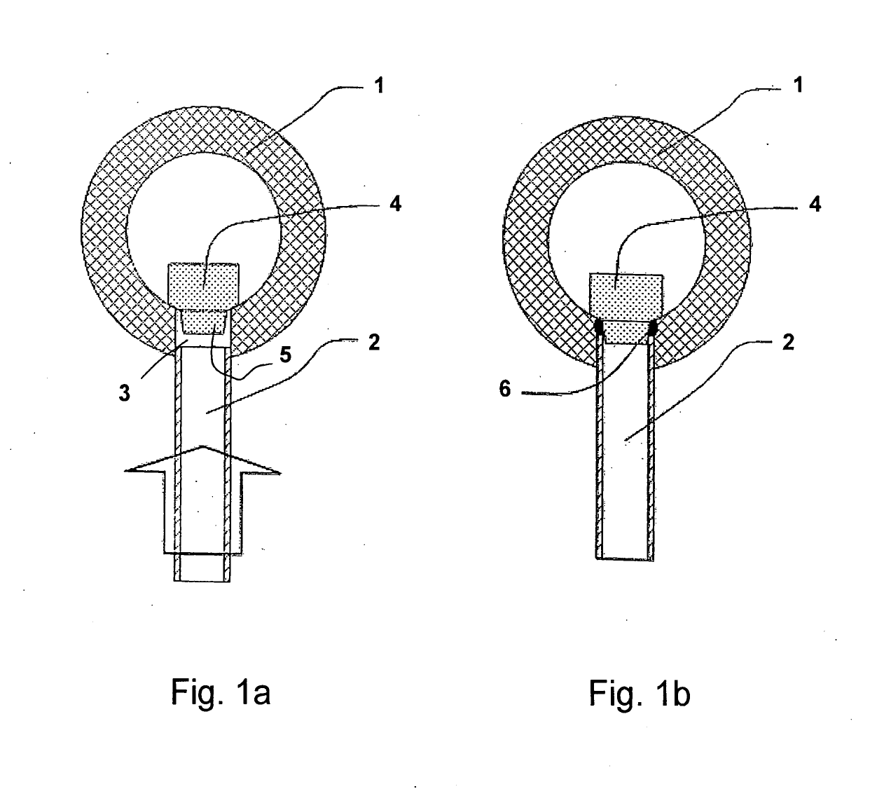

FIGS. 1a and 1b two method steps with the manufacture of a connection between a main tube and a capillary tube, and

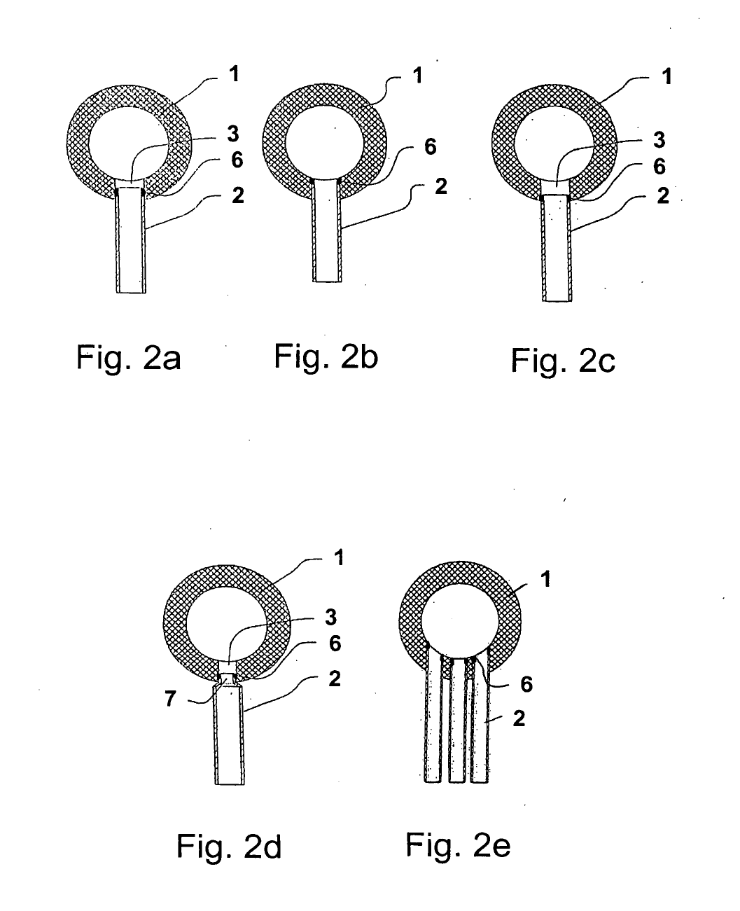

FIGS. 2a and 2b different embodiments of a connection between a main tube and at least one capillary tube.

FIG. 1a shows a main tube 1 and a capillary tube 2 which is to be connected to this, in each case in cross section. The main tube 1 and the capillary tube 2 consist in each case of plastic and serve preferably as a component of a heat exchanger mat, with which the ends of a multitude of capillary tubes on the one hand are connected to a main tube for the supply of a heating or cooling medium and on the one hand to a main tube for leading away the heating or cooling medium. The capillary tubes to be connected to a main tube lie one after the another in the longitudinal direction of the main tube, wherein it may be desirable for the distances between adjacent capillary tubes to be as low as possible.

Typical dimensions with such heat exchanger mats are an outer diameter of 20 mm and an inner diameter of 16 mm for the main tube 1 as well as an outer diameter of 3.0 mm and an inner diameter of 2.4 mm for the capillary tube 2.

In the present example, the main tube has a round cross section. This may however be arbitrary, for example it may be rectangular or oval. For the simplified implementation of the method according to the invention, it may also be divided in the longitudinal direction horizontally roughly in the middle, wherein the lower half which is accessible from above is firstly connected to the capillary tubes and then the upper half is welded to the lower half for forming the closed main tube.

The main tube 1 for the connection to a capillary tube 2, in each case has a radial passage 3 which is round in cross section and whose diameter corresponds to the outer diameter of the capillary tube 2. The end of the capillary tube 2 may thus be pushed into the passage 3 without shape change. The outer diameter of the capillary tube 2 may however also to a certain extent be smaller than the outer diameter of the passage 3, without excessively compromising the ability of the present method to be implemented.

A rod extending 4 over the length of the main tube 1 is introduced into this main tube before the welding procedure. The rod 4 on its side which faces the passage 3 in each case carries a heating punch 5 for each of the passages 3 present in the main tube 1 and this heating punch 5 may be electrically heated via a lead guided through the rod 4. The rod 4 is thus pressed onto the inner wall of the main tube 1 such that the heating punches 5 in each case project centrally into the passage 3, and an annular gap is formed between the heating punch 5 and the wall of the passage 3. The heating punch 5 tapers slightly in the direction of the passage 3, so that it has a shape of a truncated cone. The gap between the heating punch 5 and the wall of the passage 3 is dimensioned such that in the region of the end-face of the heating punch 5, it has a width which is larger than the wall thickness of the capillary tube 2, so that the capillary tube 2 which is pushed from below into the passage 3, firstly gets into this gap and, when its front edge meets the end-face of the heating punch 5, begins to plasticise from its end face. By way of this plastification, the capillary tube 2 may be pushed further into the tapering gap, until its end-face hits the rod 4. The softened or melted material of the front edge region of the capillary tube 2 is also pressed outwards against the wall of the passage 3, so that this too begins to soften. Due to the lasting pressure from below, a gapless welding zone is formed, which when the pressure exertion is finished and the heating punch 5 is subsequently removed from the passage 3 by way of lifting the rod 4, cools and solidifies, so that a homogonous welding seam 6 is obtained.

The welding seam 6 between the capillary tube 2 and the main tube 1 may be limited to a very small region, whose size is determined alone by the outer diameter of the capillary tube on the one hand, and the necessary width of the welding seam 6, i.e. its dimensions in the longitudinal direction of the capillary tube 2, on the other hand. The theoretically necessary width of the welding seam 6 corresponds to the thickness of the wall of the capillary tube 2, in the present case thus 0.3 mm. Even if this is increased to 0.4 mm for accommodating manufacturing tolerances, the area of the welding seam is only about 4 mm² large, compared to more than 60 mm² with the method according to DE 197 25 325 C2 with a welding corona of typically approx. 9 mm diameter.

The welding may be carried out with all conventional methods, e.g. ultrasound welding or thermal welding. For capillary tube mats however, until now one has exclusively used the thermal welding for economical reasons. Typical cycle times for the welding procedure lie at 180 seconds for the necessary working cycles of “reheating the two contact surfaces, pressing together and cooling”.

It has been found that with the method according to the invention, these times may be surprisingly shortened to less than 20 seconds. This is due mainly to the low supply of heat through the welding area which is smaller by more than a power of ten. Another reason is the simplified course or procedure of welding, since it is no longer necessary for the two welding surfaces of the main tube 1 and the capillary tube 2 to be pre-treated separately, as the case may be, also deformed, by way of heating.

The subsequent cooling also takes its course much more rapidly than with conventional methods, since the main tube which has more that 98% of the material quantity participating in the process, is hardly heated at all. The cooling process may be yet accelerated by way of the main tube and/or the capillary tube 2 being held at a temperature which is lower compared to the surrounding temperature.

The economical value of the method according to the invention is therefore very large since the capacity of a production installation for capillary tube mat is determined to 80% by the waiting times with the welding procedure. The reduction of the welding time to below 20% increases the capacity to more than threefold without additional investment costs.

The FIGS. 2a to 2d show different variants of the position of the welding seam 6 in the passage 3. This may be influenced by way of a suitable design of the rod 4 or of the heating punch 5.

Thus according to FIG. 2a, the welding seam 6 lies roughly in the middle of the passage 3. This is achieved by way of a connection piece being arranged between the rod 4 and the heating punch 5, the length of which connection piece corresponding to roughly half the length of the passage and whose diameter is smaller than that of the heating punch 5. The outer surface of the connection piece is preferably thermally insulated.

FIG. 2b shows the case represented in FIG. 1, in which the capillary tube 2 is advanced up to the inner wall of the main tube 1. This variant is preferably used for main tubes which consist of a glass-fibre-reinforced middle layer and in each case of an inner and outer layer which consists of a material such as polypropylene that is impermeable to the heating or cooling medium, in particular water. Since one may not ensure that the glass-fibre-reinforced layer is adequately water-impermeable, a contact between this and the heating or cooling medium should be avoided. This is achieved by the capillary tube which is advanced up to the inner wall of the main tube and which there is welded on.

According to FIG. 2c, the capillary tube is only pushed so far into the passage 3 that the welding seam 6 reaches up to the outer wall of the main tube 1. By way of this, the cooling procedure may be accelerated if the capillary tube 2 is cooled from the outside during the welding procedure.

With the variant according to FIG. 2d, the diameter of the passage 3 is reduced and the end 7 of the capillary tube is accordingly tapered. Since a certain material strength must remain between adjacent passages 3 in the main tube 1, this design permits an even smaller distance between adjacent capillary tubes 2.

The variant according to FIG. 2e shows a main tube 1 with several, here three, capillary tubes 2 which are welded on in the peripheral direction of the main tube 1. Such a configuration may be advantageous if the main tube is connected to several capillary tube mats. The connections to the capillary tubes of a mat lie one after the other in the longitudinal direction of the main tube, and the connections to the capillary tubes of different mats lie next to one another in the periphery direction, i.e. FIG. 2e shows the connection in each case to a capillary tube of three different mats.

The eccentric connection between the capillary tubes 2 of only one mat and the main tube 1, for example only the right capillary tubes 2 in FIG. 2e, may make sense if the mat e.g. is used as a cooling cover. It then lies in a flat manner on a metal plate, wherein the contact surface of the mat should be as large as possible. This permits the eccentric connection between the capillary tubes 2 and the main tube 1, when the mat is applied such that the connection lies closer to the plate than a roughly centric connection.

1-16. (canceled)

17. A method for connecting the open end of a plastic tube with an outer diameter of up to 5 mm (capillary tube) to a main tube of a significantly larger diameter and consisting of plastic, in a manner such that the capillary tube projects radially from the peripheral surface of the main tube, and the inside of the capillary tube is connected to the inside of the main tube via a radial passage which is formed in the wall of the main tube, wherein a capillary tube is applied, whose end has an outer diameter which corresponds to the diameter of the passage or is smaller, that the end of the capillary tube is introduced from the outside at least partly into the passage, and that a common heating at least of a part of the introduced end of the capillary tube and of the directly surrounding part of the wall of the passage in the main tube is carried out such that these plasticise and are welded to one another after cooling.

18. The method according to claim 17, wherein the heating is carried out by way of introducing a heating punch from the inside of the main tube, into the passage.

19. The method according to claim 17, wherein the extension of the welding seam in the longitudinal direction of the capillary tube corresponds roughly to its wall thickness.

20. The method according to claim 17, wherein the main tube has an outer diameter of about 20 mm.

21. The method according to claim 17, wherein several capillary tubes are connected with a close mutual distance in the longitudinal direction and/or the peripheral direction of the main tube, to this main tube.

22. The method according to claim 18, wherein the heating punch is designed truncated-cone-shaped tapering towards the capillary tube.

23. The method according to claim 18, wherein the heating punch is electrically heated.

24. The method according to claim 18, wherein the heating punch is attached on a movable rod in a manner extending radially from this rod, said rod extending through the main tube in the longitudinal direction of this.

25. The method according to claim 24, wherein the rod carries several heating punches which are arranged one after the other in its longitudinal direction.

26. The method according to claim 17, wherein the diameter of the end of the capillary tube which is introduced into the main tube, is reduced compared to the diameter of this capillary tube outside the main tube.

27. The method according to claim 17, wherein the position of the welding seam within the passage is determined by the introduction of the capillary tube with a corresponding depth into this.

28. The method according to claim 17, wherein the main tube and/or the capillary tube are cooled.

29. A connection between the respective inside of a thin-walled plastic tube with an outer diameter of up to 5 mm (capillary tube) and of a main tube consisting of plastic and with a significantly larger diameter for leading through a heating medium or cooling medium, wherein the connection is effected via an end-side opening of the capillary tube and a radial passage in the wall of the main tube, wherein the capillary tube with its end which comprises the end-side opening and whose outer diameter corresponds to the diameter of the passage or is smaller than this, projects from outside into at least a part of the passage, and an annular welding seam exists between the end of the capillary tube and the wall of the passage.

30. The connection according to claim 29, wherein the capillary tube projects at least so far into the passage, that the welding seam is located completely within the passage.

31. The connection according to claim 29, wherein the welding seam in the longitudinal direction of the capillary tube has an extension which corresponds at least to the wall thickness of the capillary tube.

32. The connection according to claim 29, wherein the longitudinal axis of the capillary tube goes through the longitudinal axis of the main tube or goes past this at a defined distance.
